(19) United States
(12) Patent Application Publication
(10) Pub. No.: US 2007/0126654 A1
(43) Pub. Date: Jun. 7, 2007

(54) Display device

(75) Inventors: Sun-Hyung Choi, Hwaseong-si (KR); Kil-Soo Choi, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/607,787

(22) Filed: Nov. 30, 2006

(30) Foreign Application Priority Data
Dec. 2, 2005 (KR) 10-2005-0116956

(51) Int. Cl. G09G 5/00

(52) U.S. Cl. 345/1.1

(57) ABSTRACT

The present invention relates to a display device. The display device according to the present invention includes a first display panel for displaying an image in a first display direction, a second display panel for displaying an image in a second display direction that is substantially opposite to the first display direction, and a supporting frame for supporting the first display panel and the second display panel. The first display panel and the second display panel are arranged such that an imaginary line orthogonal to a display surface of the first display panel does not pass through the second display panel. The invention allows a multiple-display-panel device, such as a flip-type cellular phone, to be more compact.

### CROSS-REFERENCE TO RELATED APPLICATION

This application claims priority to and the benefit of Korean Patent Application No. 10-2005-0116956 filed in the Korean Intellectual Property Office on Dec. 2, 2005, the entire content of which is incorporated herein by reference.

### BACKGROUND OF THE INVENTION

(a) Field of the Invention

The present invention relates to a display device. More particularly, the present invention relates to a display device with reduced thickness that includes a plurality of display panels for displaying images in opposite directions.

(b) Description of the Related Art

Along with the rapid development of semiconductor in recent years, demand for display devices, such as small and light LCDs (liquid crystal displays) has explosively increased.

Liquid crystal displays have been getting much attention as a candidate for next-generation mainstream display that replaces the CRT (cathode ray tube). LCDs have numerous advantages over CRT such as compact shape, light weight, and low power consumption, and is now used for almost all information processing devices requiring a display device. For example, middle and large-sized products such as monitors and TVs, as well as small-sized products such as mobile phones and PDAs (portable digital assistants), often incorporate an LCD.

A typical mobile phone is a flip phone, which usually has a display panel on both the front and back of the portion that flips open. While this dual-panel arrangement provides convenience to the user, such as the ability to check the time without having to flip-open the phone, it also has a disadvantage. For example, the incorporation of two display panels increases the total thickness of the mobile phone, making the phone bulkier. Accordingly, it would be desirable to produce a display device that is thinner and simpler in structure.

Further, the conventional dual display device utilizes flexible printed circuit boards for supplying driving signals to each display panel, thereby complicating the entire structure.

In addition, in the conventional dual display device, because a driver IC is mounted on one side of each display panel, the area for displaying an image cannot be widened.

### SUMMARY OF THE INVENTION

The present invention is capable of reducing the thickness of a display device that has a plurality of display panels. Further, the present invention provides a display device including a display panel having a wide effective display area and a simple structure.

In one aspect, the present invention provides a display device including a first display panel for displaying an image in a first display direction, a second display panel for displaying an image in a second display direction that is substantially opposite to the first display direction, and a supporting frame for supporting the first display panel and the second display panel. In the display device, the first display panel and the second display panel are arranged such that an imaginary line orthogonal to a display surface of the first display panel does not pass through the second display panel.

The first display panel and the second display panel may be parallel to each other.

The first display panel and the second display panel are spaced apart from each other in the direction of the imaginary line.

The supporting frame may include a first supporter for supporting the first display panel and a second supporter extending in a direction parallel to the surface of the first display panel from one end of the first supporter, and supporting the second display panel.

The display device may further include a backlight assembly for supplying light to the first display panel and the second display panel.

The backlight assembly may include a first backlight unit for supplying light to the first display panel and a second backlight unit for supplying light to the second display panel.

The first backlight unit may be received and supported by the first supporter of the supporting frame, and the second backlight unit may be received and supported by the second supporter of the supporting frame.

A light emitting direction from the second backlight unit to the second display panel may be opposed to a light emitting direction of the first backlight unit to the first display panel.

The display device may include a first flexible printed circuit board connected to one side of the first display panel and a second flexible printed circuit board connected to one side of the second display panel.

The display device may include a first driver IC chip mounted on one side of the first display panel that is connected with the first flexible printed circuit board and a second driver circuit chip mounted on one side of the second flexible printed circuit board that is connected to the second display panel.

A plurality of light-emitting diodes (LEDs) may be mounted on the first flexible printed circuit board and the second flexible printed circuit board.

The display device may include a first flexible printed circuit board connected to one end of the first display panel and a second flexible printed circuit board that connects the other end of the display panel to the second display panel.

The display device may include a first driver IC chip mounted on one side of the first display panel connected with the first flexible printed circuit board and a second driver IC chip mounted on the second flexible printed circuit board.

A plurality of light-emitting diodes (LED) may be mounted on the first flexible printed circuit board.

The first display panel and the second display panel may be liquid crystal panels.

Accordingly, the total thickness of the display device can be slim while having a plurality of display panels. Further, the effective display area of the display panel can be maximized and the entire structure thereof can be simplified.

### BRIEF DESCRIPTION OF THE DRAWINGS

FIG. 1 is an exploded perspective view of a display device according to a first exemplary embodiment of the present invention.

FIG. 2 is a cross-sectional view of the display device of FIG. 1.

FIG. 3 is a block diagram of a display panel of a display device and a configuration for driving the display panel.

FIG. 4 is an equivalent circuit for a pixel of the display panel of FIG. 3.

FIG. 5 is an exploded perspective view of a display device according to a second exemplary embodiment of the present invention.

FIG. 6 is a cross-sectional view of the display device of FIG. 5.

### DETAILED DESCRIPTION OF THE EMBODIMENTS

A display device according to an exemplary embodiment of the present invention is described as follows with reference to the accompanying drawings. In the drawings, a small display device using two display panels, e.g., a display device used for a dual flip-type mobile phone (cellular phone), is schematically illustrated by way of exemplary embodiments. The embodiments according to the present invention are examples, and they do not limit the present invention.

In the description to follow, constituent elements having the same configurations are designated by the same reference numerals in the subsequent exemplary embodiments, and are described hereafter with reference to the first exemplary embodiment. Further, in the subsequent exemplary embodiments, only the configurations that are different from the first exemplary embodiment are described.

Descriptions of parts unrelated to the description are omitted in the interest of clarity, and the same or similar constituent elements are designated by the same reference numerals herein.

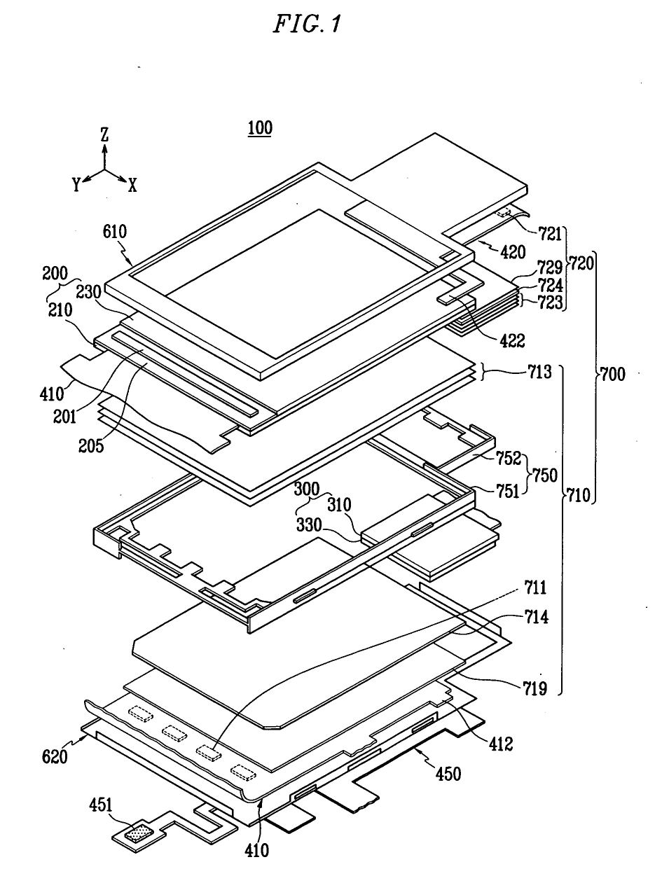

As shown in FIG. 1, a display device 100 according to the first exemplary embodiment of the present invention includes a first display panel 200 for displaying an image in the first direction, a second display panel 300 for displaying an image in the second direction that is substantially opposite to the first display direction, a supporting frame 750 for supporting the first display panel 200 and the second display panel 300, and a backlight assembly 700 for supplying light to the first display panel 200 and the second display panel 300. The display device 100 further includes flexible printed circuit boards (FPCBs) 410 and 420 for supplying a driving signal to the first display panel 200 and the second display panel 300, respectively, and may further include a flexible printed circuit film (FPC) 450 for transmitting power and other signals to the flexible printed circuit boards 410 and 420 or the backlight assembly 700. Further, the display device 100 includes a first supporting member 610 and a second supporting member 620 coupled with the supporting frame 650 for receiving or supporting the backlight assembly 700 and the flexible printed circuit boards 410 and 420, and may include other desired parts.

The first display panel 200 is larger than the second display panel 300 that is positioned substantially parallel to the first display panel 200. The display device 100 may be used particularly for a flip-type mobile phone, in which case the first display panel 200 would typically be disposed on the surface that is an inside surface when the mobile phone is closed, and the second display panel 300 would be disposed on the outside surface. Accordingly, a user can have access to a small amount of information such as time, etc., through the second display panel 300 with a small display region when the flip-phone is closed, and can have access to a relatively large amount of information through the first display panel 200 with a large display region by opening the flip-phone. The first display panel 200 and second display panel 300 are disposed such that they do not overlap each other (i.e., one is not on top of the other) and are in substantially parallel planes. In other words, the second display panel 300 is disposed such that an imaginary line that is orthogonal to the display surface of the first display panel 200 does not pass through the second display panel 300. By arranging the two display panels 200, 300 so that they are not on top of each other, the overall thickness of the display device 100 can be reduced.

Transflective or semi-transflective liquid crystal panels are shown in FIG. 1 as the first display panel 200 and second display panel 300, but this is but an example of the present invention and the present invention is not limited thereto. Therefore, a reflective liquid crystal panel or other light-receiving display panel may be used. An OLED panel (organic light-emitting display panel) may also be used.

The flexible printed circuit boards include a first flexible printed circuit board 410 connected to one side of the first display panel 200 and a second flexible printed circuit board 420 connected to one side of the second display panel 300 and connected with the first flexible printed circuit board 410. The flexible printed circuit boards 410 and 420 are shown as disconnected in FIG. 1 for convenience of illustration, but they are connected. Further, the first flexible printed circuit board 410 and the second flexible printed circuit board 420 have connecting portion 412 and 422, respectively, for connecting to each other. However, the present invention is not certainly limited to the structure shown in FIG. 1. Accordingly, the number and connection structure of the flexible printed circuit boards 410 and 420 may be changed in a wide variety of ways.

The flexible printed circuit boards 410 and 420 transmit signals for forming images to the first display panel 200 and the second display panel 300, respectively. Further, a mobile phone connector 451 is mounted on the end of the flexible printed circuit film 450 that is connected with the first flexible printed circuit board 410. With this configuration, the flexible printed circuit boards 410 and 420 receive signals corresponding to the extent of opening and closing of the folder of a mobile phone through the mobile phone connector 451.

The first flexible printed circuit board 410 and the second flexible printed circuit board 420 have a first light source unit 711 and a second light source unit 721, respectively. The first light source unit 711 and the second light source unit 722 are light-emitting diodes (LEDs).

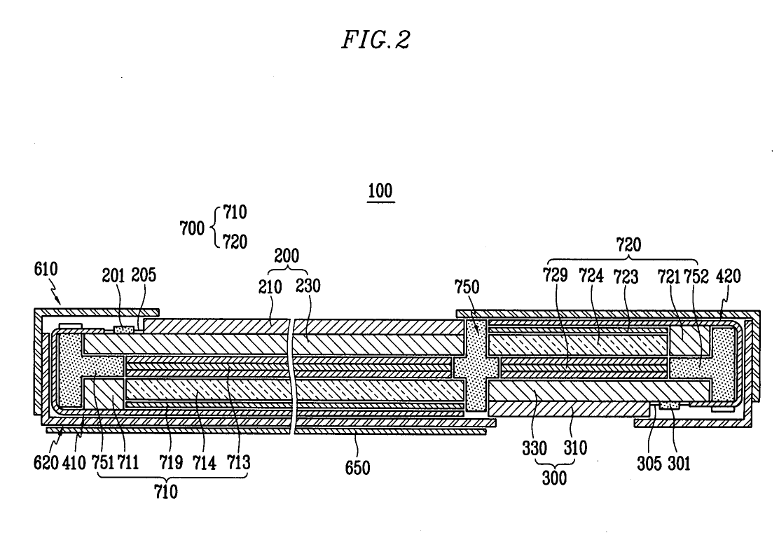

The display device 100 further includes a first driver IC chip 201 mounted on one side of the first display panel 200 connected with the first flexible printed circuit board 410 and a second driver IC chip 301 on one side of the second display panel 300 connected with the second flexible printed circuit board 420. In this configuration, the first driver IC chip 201 and the second driver IC chip 301 are surrounded by passivation layers 205 and 305, respectively. The second driver IC chip 301 and the passivation layer 305 covering the second drive IC chip 301 are shown in FIG. 2.

The backlight assembly 700 includes a first backlight unit 710 for supplying light to the first display panel 200 and a second backlight unit 720 for supplying light to the second display panel 300.

The first backlight unit 710 and the second backlight unit 720 include the first light source unit 711 and the second light source unit 721 for generating light; a first light guide 714 and second light guide 724 for guiding the light out of the light source units 711 and 721 to the first display panel 200 and the second display panel 300; a first reflecting sheet 719 and second reflecting sheet 729 disposed on the rear surface of the light guides 714 and 724, respectively; and a first optical sheet 713 and a second optical sheet 723 disposed between the light guides 714 and 724 and the display panels 200 and 300, respectively, for improving the luminance and diffusing the light more uniformly. The first backlight unit 710 and the second backlight unit 720 are supported and received by the supporting frame 750 and supporting members 610 and 620.

Light-emitting diodes (LEDs) directly mounted on the first flexible printed circuit board 410 and second flexible printed circuit board 420 are shown in FIG. 1 as light source units 711 and 721, respectively. Because the light source units 711 and 721 are directly mounted on the flexible printed circuit boards 410 and 420 as described above, the entire configuration of the display device 100 can be simple. However, such a configuration is but an example of the present invention, and the present invention is not limited to the configuration. Therefore, the light source units 711 and 721 are not necessarily directly mounted on the flexible printed circuit boards 410 and 420. For example, a linear light source or a planar light source of a modulated light-emitting diode (LED) may be used instead. Further, the number of light-emitting diodes (LEDs) is not limited to the example shown in FIG. 1, and is variable if necessary.

The supporting frame 750 includes a first supporter 751 supporting the display panel 200 and a second supporter 752 extending in a direction parallel with the surface of the first display panel 200 at one side of the first supporter 751, for supporting the second display panel 300. As described above, the first display panel 200 and the second display panel 300 can be supported by the supporting frame 750 such that they do not overlap each other. The supporting frame 750 supports the first display panel 200 and second display panel 300 such that the two panels display images in different (substantially opposite) directions. Further, the first backlight unit 710 of the backlight assembly 700 is received and supported by the first supporter 751 of the supporting frame 750, and the second backlight unit 720 of the backlight assembly 700 is received and supported by the second supporter 752 of the supporting frame 750.

As shown in FIG. 2, in the display device 100 according to the first exemplary embodiment of the present invention, light is emitted downward from the second backlight unit 720 to the second display panel 300 while light is emitted upward from the first backlight unit 710 to the first display panel 200. That is, a light emitting direction of the first backlight unit 710 to the first display panel 200 is opposed to a light emitting direction from the second backlight unit 720 to the second display panel 300.

According to the above configuration, the second display panel 300 does not overlap the first display panel 200 and is parallel to the first display panel 200. Thus, the total thickness of the display device 100 can be decreased. Further, the first backlight unit 710 for lighting the first display panel 200 and the second backlight unit 720 for lighting the second display panel 300 are individually driven, so that the first display panel 200 or the second display panel 300 is not unnecessarily lit. In other words, when only the first display panel 200 is intended to be used, it is possible not to light the second display panel 300; similarly, when only the second display panel 300 is intended to be used, it is possible not to light the first display panel 200.

The first display panel 200 and the second display panel 300 include, respectively, the first sub-display panels 210 and 310 and the second sub-display panels 230 and 330, and polarizers (not shown) attached to the outer surface of the first sub-display panels 210 and 310 and the second sub-display panels 230 and 330.

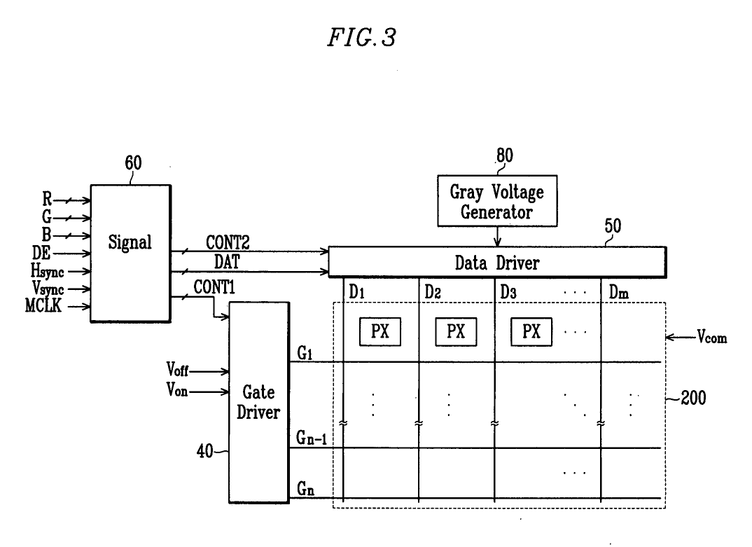

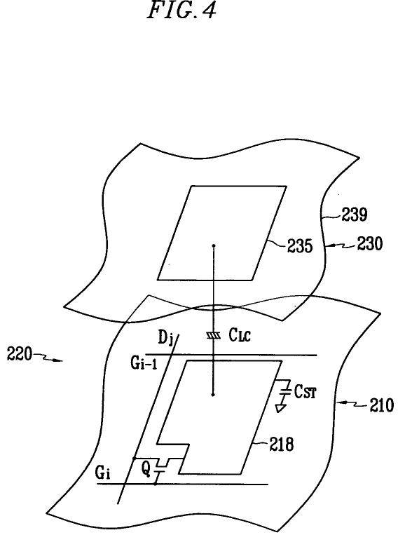

The internal structure of the first display panel 200 of a liquid crystal panel and a configuration for driving it are described below in detail, referring to FIG. 3 and FIG. 4. As the second display panel 300 has substantially the same structure as the first display panel 200, the second display panel 300 will not be described in detail.

As shown in FIG. 3 and FIG. 4, the first display panel 210 includes a plurality of signal lines G₁ to Gₙ and D₁ to Dₘ, and the first sub-display panel 210 and the second sub-display panel 230 are connected with the signal lines G₁ to Gₙ and D₁ to Dₘ and include a plurality of pixels arranged substantially in a matrix form.

The signal lines G₁ to Gₙ and D₁ to Dₘ include a plurality of gate lines G₁ to Gₙ for transmitting gate signals (also called “scanning signals”) and data lines D₁ to Dₘ for transmitting data signals. The gate lines G₁ to Gₙ extend substantially in a first direction and parallel to each other, and the data lines D₁ to Dₘ extend substantially in a second direction and parallel to each other. The first and second directions are substantially perpendicular to each other.

Each pixel includes a switching element Q connected with the signal lines G₁ to Gₙ and D₁ to Dₘ and a liquid crystal capacitor C_{LC} and a storage capacitor C_{ST} connected to the switching element Q. The storage capacitor C_{ST} may be omitted if necessary.

A thin film transistor may be an example of the switching element Q, which is formed on the first sub-display panel 210. The thin film transistor is a three terminal element, of which the control terminal and input terminal are connected with the gate lines G₁ to Gₙ and data lines D₁ to Dₘ, respectively, and the output terminal is connected with the liquid crystal capacitor C_{LC} and storage capacitor C_{ST}.

The first driver IC chip 201 (shown in FIG. 1) includes a signal controller 60, a gate driver 40 and data driver 50 connected to the signal controller 60, and a gray voltage generator 80 connected to the data driver 50.

The signal controller 60 controls the gate driver 40 and data driver 50. The gate driver 40 applies gate signals formed of a combination of a gate-on voltage Von and a gate-off voltage Voff to the gate lines G₁ to Gₙ, and the data driver 50 applies data voltages to the data lines D₁ to Dₘ. The gray voltage generator 80 generates two pairs of a plurality of gray voltages for the transmittance of the pixels, and provides them the data driver 50 as data voltages. One pair of the gray voltages has a positive value with respect to the common voltage Vcom, and the other has a negative value.

As shown in FIG. 4, the liquid crystal capacitor C_{LC} has two terminals of a pixel electrode 218 of the first display panel 210 and a common electrode 239 of the second display panel 230, and a liquid crystal layer 220 between the electrodes 218 and 239 functions as a dielectric material. The pixel electrode 218 is connected to the switching element Q, and the common electrode 239 is formed over the entire surface of the second display panel 230 and receives the common voltage Vcom. Unlike FIG. 4, the common electrode 239 may be included in the first display panel 210, and at least one of the two electrodes 218 and 239 may be formed in a linear or bar shape. Further, a color filter 235, which imparts color to passing light, is formed on the second sub-display panel 230. The color filter 235 may also be formed on the first sub-display panel 210, dissimilar to FIG. 4.

The storage capacitor C_{ST} that is subsidiary to the liquid crystal capacitor C_{LC} is formed by overlapping an individual signal line (not shown) on the first sub-display panel 210 with the pixel electrode 218 sandwiching an insulator. A predetermined voltage, such as the common voltage Vcom, is applied to the signal line. However, the storage capacitor C_{ST} may alternatively be formed by overlapping the pixel electrode 218 with the gate lines G₁ to Gₙ that are directly thereabove through an insulator.

According to the above configuration, when a switching element, e.g., a thin film transistor is turned on, an electric field is formed between the pixel electrode 218 and common electrode 239. The electric field changes the orientation angle of the liquid crystal of the liquid crystal layer 220 between the first display panel 210 and second display panel 230, and a desired image is obtained by light transmission depending on the angle. Such a structure and driving method of the display panel 200 is also applicable to the second display panel 300.

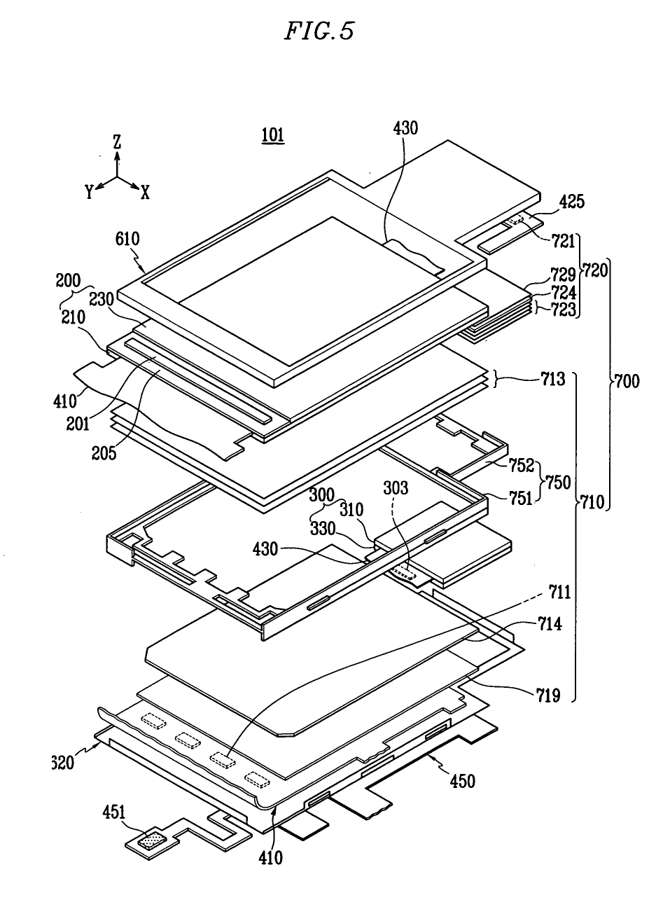

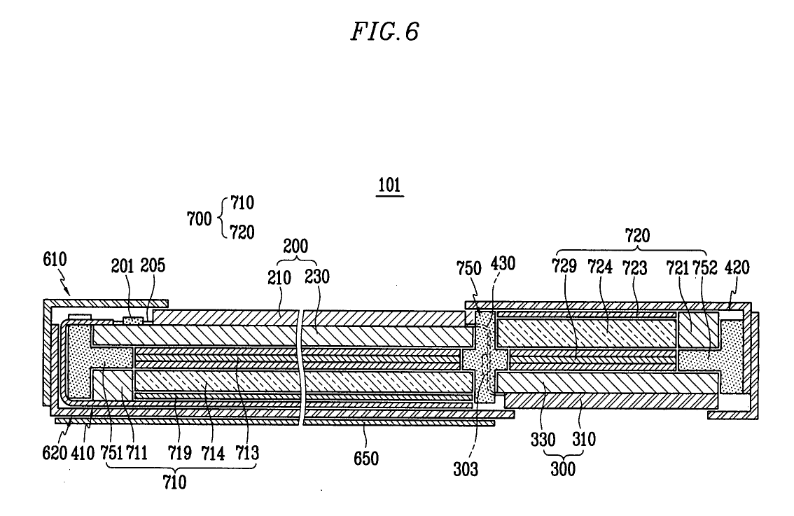

The display device 101 according to the second exemplary embodiment of the present invention is now described referring to FIG. 5 and FIG. 6.

As shown in FIG. 5, the display device 101 includes a first flexible printed circuit board 410 connected to one side of the first display panel 200, and a second flexible printed circuit board 430 connecting the other side of the first display panel 200 with one side of the second display panel 300. The flexible printed circuit boards 410 and 430 are shown as disconnected in FIG. 5 for convenience of illustration, but they are connected.

According to the above configuration, a signal from the first flexible printed circuit board 410 is transmitted to the first display panel 200 and is then transmitted to the second display panel 300 through the second flexible printed circuit board 430.

The first driver IC chip 201 is mounted on one side of the first display panel 200 that is connected with the first flexible printed circuit board 410, and the second driver IC chip 303 is mounted on the second flexible printed circuit board 430. In other words, the second flexible printed circuit board 430 is formed of a COF (chip on film) having the second driver IC chip 303 for driving the second display panel 300. As described above, no driver IC chip is mounted on the second display panel 300, so that an effective image-displaying area of the second display panel 300 can be maximized.

Further, the first display panel 200, the second display panel 300, and the flexible printed circuit boards 410 and 430 for driving them may be integrally formed as one set, thus simplifying the entire structure of the display device 101.

In this configuration, the first light source unit 711 of the first backlight unit 710 for lighting the first display panel 200 is mounted on the first flexible printed circuit board 410. On the other hand, a second light source unit 721 of the second backlight unit 720 for lighting the second display panel 300 is mounted on an individual circuit board 425 for a light source. The circuit board for a light source is connected with the first flexible printed circuit board 410 or flexible printed circuit film 450, and is powered to drive the light source.

As shown in FIG. 6, the display device 101 according to the second exemplary embodiment of the present invention is sequentially connected with the first flexible printed circuit board 410, the first display panel 200, the second flexible printed circuit board 430, and the second display panel 300.

As described above, according to the configuration of FIG. 6, the second display panel 300 does not overlap the display panel 200 and is parallel therewith, and the first display panel 200 and the second display panel 300 as well as the flexible printed circuit boards 410 and 430 for driving them are formed as one set. Therefore, the total thickness of the display device 101 can be minimized and the structure can be simple.

Furthermore, the second driver IC chip 303 for driving the second display panel 300 is mounted not on the second display panel 300, but on the second flexible printed circuit board 430. Therefore, the effective image-displaying area of the second display panel 300 can be maximized. Accordingly, the relatively small second display panel 300 with respect to the first display panel 200 can be more effectively utilized.

As described above, the present invention allows a display device with multiple display panels to be made thin or slim. In other words, the second display panel does not overlap the first display panel and is parallel to the first display panel. Since the two display panels are not on top of each other, the total thickness of the display device can be minimized.

Further, the entire structure of the display device can be simplified because the first display panel, the second display panel, and the flexible printed circuit boards for driving them are integrally formed as one set.

In addition, the display device may have a display panel with a wide effective image-displaying area. In other words, the effective image-displaying area of the display panel can be maximized because the driver IC chip for driving the second display panel is mounted not on the second display panel, but on the flexible printed circuit board connecting the second display panel to the first display panel.

Accordingly, a relatively small second display panel with respect to the first display panel can be more effectively utilized.

While this invention has been described in connection with what is presently considered to be practical exemplary embodiments, it is to be understood by those skilled in the art that the invention is not limited to the disclosed embodiments, but, on the contrary, is intended to cover various modifications and equivalent arrangements included within the spirit and scope of the appended claims.

What is claimed is:

1. A display device comprising:
a first display panel that displays an image in a first display direction;
a second display panel that displays an image in a second display direction that is substantially opposite to the first display direction; and
a supporting frame that supports the first display panel and the second display panel,
wherein the first display panel and the second display panel are arranged such that an imaginary line orthogonal to a display surface of the first display panel does not pass through the second display panel.

2. The display device of claim 1, wherein the first display panel and the second display panel are disposed parallel to each other.

3. The display device of claim 1, wherein the first display panel and the second display panel are spaced apart from each other in the direction of the imaginary line.

4. The display device of claim 1, wherein the supporting frame comprises:
a first supporter that supports the first display panel; and
a second supporter that extends in the direction parallel to the surface of the first display panel from one end of the first supporter and supporting the second display panel.

5. The display device of claim 4, further comprising a backlight assembly that supplies light to the first display panel and the second display panel.

6. The display device of claim 5, wherein the backlight assembly comprises a first backlight unit for supplying light to the first display panel and a second backlight unit for supplying light to the second display panel.

7. The display device of claim 6, wherein the first backlight unit is received and supported by the first supporter of the supporting frame and the second backlight unit is received and supported by the second supporter of the supporting frame.

8. The display device of claim 6, wherein a light emitting direction from the second backlight unit to the second display panel is opposed to a light emitting direction of the first backlight unit to the first display panel.

9. The display device of claim 1, further comprising:
a first flexible printed circuit board that is connected to one side of the first display panel; and
a second flexible printed circuit board that is connected to one side of the second display panel.

10. The display device of claim 9, further comprising:
a first driver integrated circuit chip that is mounted on one side of the first display panel that is connected with the first flexible printed circuit board; and
a second driver integrated circuit chip that is mounted on one side of the second flexible printed circuit board that is connected to the second display panel.

11. The display device of claim 9, wherein a plurality of light-emitting diodes (LED) are mounted on the first flexible printed circuit board and the second flexible printed circuit board.

12. The display device of claim 1, further comprising:
a first flexible printed circuit board that is connected to one end of the first display panel; and
a second flexible printed circuit board that connects the other end of the display panel to the second display panel.

13. The display device of claim 12, further comprising:
a first driver integrated circuit chip that is mounted on one side of the first display panel that is connected with the first flexible printed circuit board; and
a second driver integrated circuit chip that is mounted on the second flexible printed circuit board.

14. The display device of claim 12, wherein a plurality of light-emitting diodes (LED) are mounted on the first flexible printed circuit board.

15. The display device of claim 1, wherein the first display panel and the second display panel are liquid crystal panels.
